(19) United States
(12) Patent Application Publication
(10) Pub. No.: US 2008/0120334 A1
(43) Pub. Date: May 22, 2008

(54) Database system and method

(75) Inventor: Ran Etgar, Modi'in (IL)

Correspondence Address: Brux Software Solutions Ltd., 8 Goldon Street, Givatayim, 53235, omitted

(73) Assignee: Miracom Technologies Computing Solution Ltd., Ramat Hasharon (IL)

(21) Appl. No.: 11/984,003

(22) Filed: Nov. 13, 2007

(30) Foreign Application Priority Data
Nov. 18, 2006 (GB) 0623059.3

(51) Int. Cl. G06F 17/30

(52) U.S. Cl. 707/103 Y; 707/E17.045

(57) ABSTRACT

A method for emulating an Object-Oriented database (OODB) on a Relational database, comprising: define the desired data structure as objects for an Object-Oriented database; for each object, open an RDB table; for each object, in the RDB table, define relevant fields; implement an OODB interface with the user while storing the information in RDB tables. A method for emulating an Object-Oriented database (OODB) on a Relational database and for distinguishing between OODB objects, comprising: define the desired data structure as objects for an Object-Oriented database: for each object, open an RDB table: for each object, in the RDB table, define relevant fields; allocate a unique primary number object-id to each new object; allocate a second number to each new object, wherein its value is computed as the product of its object-id and its parent's object-id; implement a method to support the application of SELECT commands over the tables using the object-id and item-id numbers, to return the relevant objects.

The invention relates to a method for emulating an Object-Oriented database on a Relational database.

At present, tabular databases (Relational Databases RDB) are in widespread use, and are the prevalent database implementation.

Another database structure, Object-Oriented Database (OODB) offers various advantages, including easier and faster development of new applications, easy maintenance, etc.

Despite their advantages, OODB systems are not as widespread as RDB, one of the main reasons being the wide variety of tools in RDB.

A changeover to OODB would require abandoning these tools.

### SUMMARY OF THE INVENTION

According to the present invention, a new system aims to offer the advantages of OODB while at the same time maintaining the wide assortment of tools available in RDB.

This is achieved using an emulator, which operates on a RDB system.

In one embodiment, the method emulates an Object-Oriented database (OODB) on a Relational database as follows:

a. define the desired data structure as objects for an Object-Oriented database;
b. for each object, open an RDB table;
c. for each object, in the RDB table, define relevant fields, wherein child objects inherit the parent's fields;
d. implement an OODB interface with the user while storing the information in RDB tables.

### BRIEF DESCRIPTION OF THE DRAWINGS

FIG. 1 illustrates the data structure in a RDB-based system with OODB emulation

FIG. 2 illustrates the data structure in a RDB-based system with OODB emulation and item ID numbers allocation

FIG. 3 details, in tabular form, the RDB data structure for object People

FIG. 4 details, in tabular form, the RDB fields for object Resources

FIG. 5 illustrates another example of data structure in a RDB-based system with OODB emulation and item ID numbers allocation

### DETAILED DESCRIPTION OF THE INVENTION

A preferred embodiment of the present invention will now be described by way of example and with reference to the accompanying drawings.

### Method 1—00DB Emulation

A method for emulating an Object-Oriented database (OODB) on a Relational database may comprise the following steps:

### 1. Define the desired data structure as objects for an Object-Oriented database.

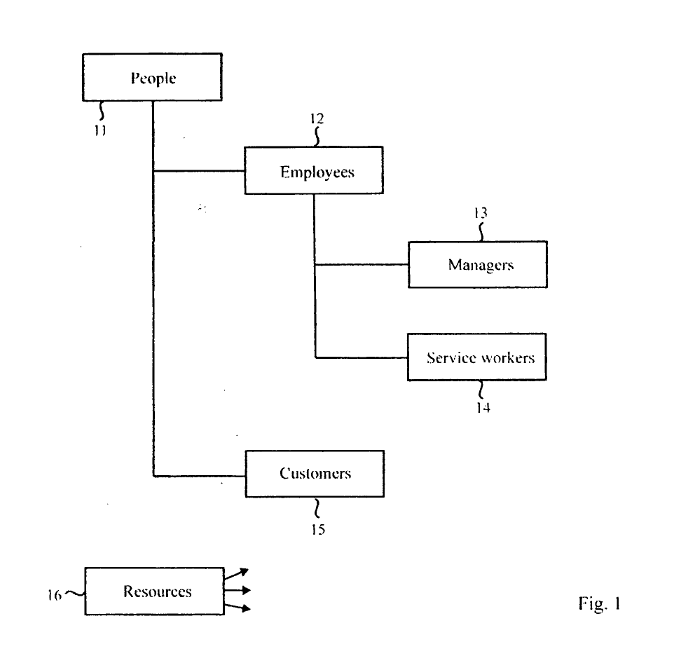

FIG. 1 illustrates, in a firm, the data structure in a RDB-based system with OODB emulation. It includes employees 12, customers 15 and resources 16.

Due to the similarity between customers and employees, they were combined into one object, People 11.

### 2. For each of the base objects, people 11 and resources 16, an RDB table has been opened.

3. For each of the objects, relevant fields have been defined. A child object, such as employees 12, inherits the field of the parent object, people 11 in this example.

The child object may include additional fields.

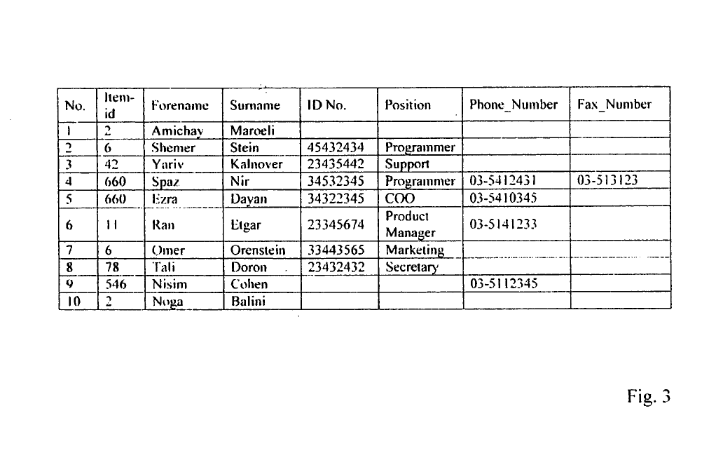

For example, FIG. 3 details, in tabular form, the RDB data structure for object People 11. Its fields may include:

### No.—serial number

### Item-id

### Forename

### Surname

### ID No.

### Position

### Phone_Number

### Fax_Number

### Managers—a list of their subordinate employees

### Customers—telephone number, fax number, email address

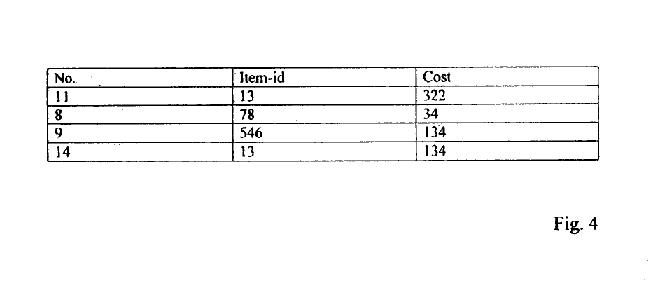

FIG. 4 details, in tabular form, the RDB fields for object Resources 16.

Its fields may include:

### No.—serial number

### Item-id

### Cost

4. Implement an OODB interface with the user while storing the information in RDB tables. This is the OODB emulator, which provides the OODB benefits while using the multitude of tools available in RDB.

### End of Method.

### Method 2 for Distinguishing Between OODB Objects

The method provides for a one-to-one identification of the records in the RDB table, including:

### 1. A primary number, object-id, will be allocated to each new object.

2. A second number, item-id, will be allocated to each new object. Its value will be computed as the product of its object-id and its parent's object-id

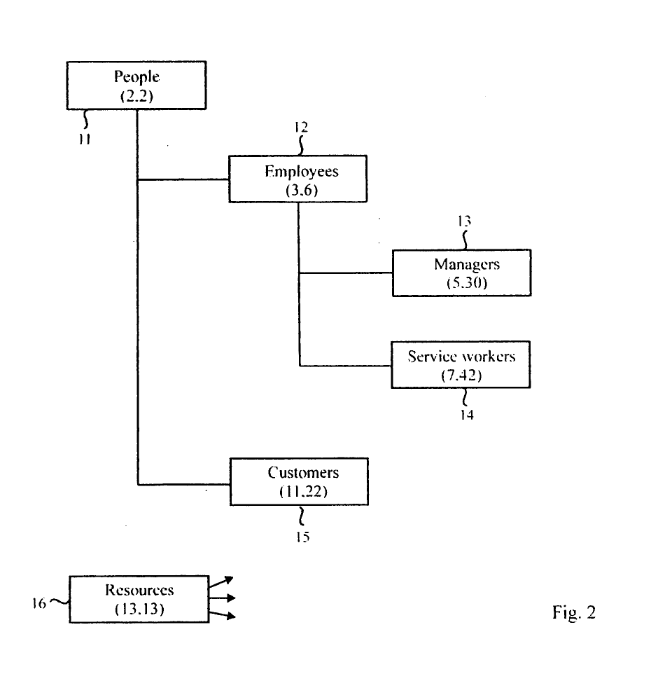

### 3. In the example as shown, see FIG. 2:

### People 11 (2,2)

### Employees 12 (3,6)

### Managers 13 (5,30)

### Service workers 14 (7,42)

### Customers 15 (11,22)

### Resources 16 (13,13)

Explanation: Each object was allocated a prime number, in the order of their conception (the order is irrelevant).

Customers received item-id computed as the product of its object-id (2) and its parent's (People=2).

Managers received an object-id of 5 and item-id of 5*6=30, etc.

### 4. The structure of the tables is simple, see for example FIGS. 3 and 4.

### 5. The item-id supports the application of SELECT commands over the tables, which will then return the relevant objects (views).

For example:

a. Retrieval of People 11

### Select forename, surname from People where (item-id mod 2)=0

b. Retrieval of all Employees from table People

### Select forename, surname, employee-id, position from People where (item-id mod 6)=0

c. Retrieval of all Managers

### Select forename, surname, employee-id, position from People where (item-id mod 30)=0

d. Retrieval of all Service people

### Select forename, surname, employee-id, position from People where (item-id mod 42)=0

e. Retrieval of all Customers

### Select forename, surname, phone, fax, email from People where (item-id mod 22)=0

e. Retrieval of all Resources

### Select cost from resources where (item-id mod 13)=0

### End of Method.

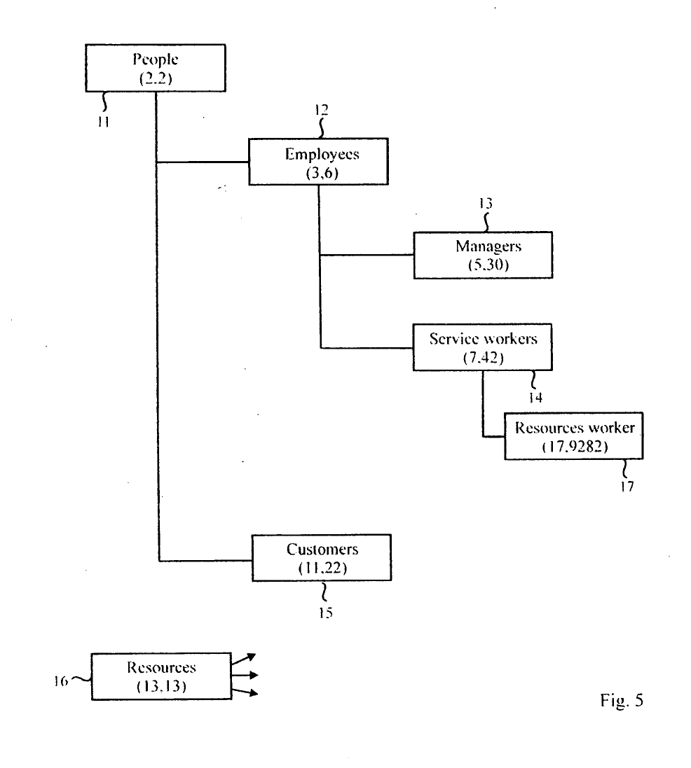

Similarly, it is possible to create an object as the child of two parents. For example, employees may be defined as resources. A new object is thus created: Resources worker 17, see FIG. 5.

Explanation: A Resources worker is a legitimate object, therefore it will receive the next available prime number (17). Moreover, it will inherit from Service worker 14, therefore its number is: 17*42*13=9282.

There are eight mandatory features of RDB, and the above system and method complies with them all:

### 1. Complex Objects

Complex objects are built from simpler ones by applying constructors to them. The simplest objects are objects such as integers, characters, byte strings of any length, booleans and floats (one might add other atomic types). There are various complex object constructors: tuples, sets, bags, lists, and arrays are examples.

The minimal set of constructors that the system should have are set, list and tuple. Sets are critical because they are a natural way of representing collections from the real world. Tuples are critical because they are a natural way of representing properties of an entity. Of course, both sets and tuples are important because they gained wide acceptance as object constructors through the relational model. Lists or arrays are important because they capture order, which occurs in the real world, and they also arise in many scientific applications, where people need matrices or time series data.

The object constructors must be orthogonal: any constructor should apply to any object. The constructors of the relational model are not orthogonal, because the set construct can only be applied to tuples and the tuple constructor can only be applied to atomic values. Other examples are non-first normal form relational models in which the top level construct must always be a relation.

Note that supporting complex objects also requires that appropriate operators must be provided for dealing with such objects (whatever their composition). That is, operations on a complex object must propagate transitively to all its components. Examples include the retrieval or deletion of an entire complex object or the production of a “deep” copy (in contrast to a “shallow” copy where components are not replicated, but are instead referenced by the copy of the object root only). Additional operations on complex objects may be defined, of course, by users of the system (see the extensibility rule below). However, this capability requires some system provided provisions such as two distinguishable types of references (“is-part-of” and “general”).

### 2. Object Identity

Object identity has long existed in programming languages. The concept is more recent in databases. The idea is the following: in a model with object identity, an object has an existence which is independent of its value. Thus two notions of object equivalence exist: two objects can be identical (they are the same object) or they can be equal (they have the same value).

This has two implications: one is object sharing and the other one is object updates. Object sharing: in an identity-based model, two objects can share a component. Thus, the pictorial representation of a complex object is a graph, while it is limited to be a tree in a system without object identity. Consider the following example: a People (or Person) has a name, an age and a set of children. Assume Peter and Susan both have a 15-year-old child named John. In real life, two situations may arise: Susan and Peter are parents of the same child or there are two children involved. In a system without identity, Peter is represented by:
(peter, 40, {(john, 15, { })})
   and Susan is represented by:
(susan. 41, {(john. 15, { })}).

Thus, there is no way of expressing whether Peter and Susan are the parents of the same child. In an identity-based model, these two structures can share the common part (john, 15, { }) or not, thus capturing either situations.

Object updates: assume that Peter and Susan are indeed parents of a child named John. In this case, all updates to Susan's son will be applied to the object John and, consequently, also to Peter's son. In a value-based system, both sub-objects must be updated separately. Object identity is also a powerful data manipulation primitive that can be the basis of set, tuple and recursive complex object manipulation.

Supporting object identity implies offering operations such as object assignment, object copy (both deep and shallow copy) and tests for object identity and object equality (both deep and shallow equality).

Of course, one can simulate object identity in a value-based system by introducing explicit object identifiers. However, this approach places the burden on the user to insure the uniqueness of object identifiers and to maintain referential integrity (and this burden can be significant for operations such as garbage collection).

Note that identity-based models are the norm in imperative programming languages: each object manipulated in a program has an identity and can be updated. This identity either comes from the name of a variable or from a physical location in memory. But the concept is quite new in pure relational systems, where relations are value-based.

### 3. Encapsulation

The idea of encapsulation comes from (i) the need to cleanly distinguish between the specification and the implementation of an operation and (ii) the need for modularity. Modularity is necessary to structure complex applications designed and implemented by a team of programmers. It is also necessary as a tool for protection and authorization.

There are two views of encapsulation: the programming language view (which is the original view since the concept originated there) and the database adaptation of that view.

The idea of encapsulation in programming languages comes from abstract data types. In this view, an object has an interface part and an implementation part. The interface part is the specification of the set of operations that can be performed on the object. It is the only visible part of the object. The implementation part has a data part and a procedural part. The data part is the representation or state of the object and the procedure part describes, in some programming language, the implementation of each operation.

The database translation of the principle is that an object encapsulates both program and data. In the database world, it is not clear whether the structural part of the type is or is not part of the interface (this depends on the system), while in the programming language world, the data structure is clearly part of the implementation and not of the interface.

Consider, for instance, an Employee. In a relational system, an employee is represented by some tuple. It is queried using a relational language and, later, an application programmer writes programs to update this record such as to raise an Employee's salary or to fire an Employee.

These are generally either written in a imperative programming language with embedded DML statements or in a fourth generation language and are stored in a traditional file system and not in the database. Thus, in this approach, there is a sharp distinction between program and data, and between the query language (for ad hoc queries) and the programming language (for application programs).

In an object-oriented system, we define the Employee as an object that has a data part (probably very similar to the record that was defined for the relational system) and an operation part, which consists of the raise and fire operations and other operations to access the Employee data. When storing a set of Employees, both the data and the operations are stored in the database.

Thus, there is a single model for data and operations, and information can be hidden. No operations, outside those specified in the interface, can be performed. This restriction holds for both update and retrieval operations. Encapsulation provides a form of “logical data independence”: we can change the implementation of a type without changing any of the programs using that type. Thus, the application programs are protected from implementation changes in the lower layers of the system.

We believe that proper encapsulation is obtained when only the operations are visible and the data and the implementation of the operations are hidden in the objects.

However, there are cases where encapsulation is not needed, and the use of the system can be significantly simplified if the system allows encapsulation to be violated under certain conditions. For example, with ad-hoc queries the need for encapsulation is reduced since issues such as maintainability are not important. Thus, an encapsulation mechanism must be provided by an OODBS, but there appear to be cases where its enforcement is not appropriate.

### 4. Types and Classes

There are two main categories of object-oriented systems, those supporting the notion of class and those supporting the notion of type. A type, in an object-oriented system, summarizes the common features of a set of objects with the same characteristics. It corresponds to the notion of an abstract data type. It has two parts: the interface and the implementation (or implementations). Only the interface part is visible to the users of the type, the implementation of the object is seen only by the type designer.

The interface consists of a list of operations together with their signatures (i.e., the type of the input parameters and the type of the result). The type implementation consists of a data part and an operation part. In the data part, one describes the internal structure of the object's data. Depending on the power of the system, the structure of this data part can be more or less complex. The operation part consists of procedures which implement the operations of the interface part.

In programming languages, types are tools to increase programmer productivity, by insuring program correctness. By forcing the user to declare the types of the variables and expressions he/she manipulates, the system reasons about the correctness of programs based on this typing information. If the type system is designed carefully, the system can do the type checking at compile-time, otherwise some of it might have to be deferred at compile time. Thus types are mainly used at compile time to check the correctness of the programs. In general, in type-based systems, a type is not a first class citizen and has a special status and cannot be modified at run-time.

### Ours Support Types

The notion of class is different from that of type. Its specification is the same as that of a type, but it is more of a run-time notion. It contains two aspects: an object factory and an object warehouse. The object factory can be used to create new objects, by performing the operation new on the class, or by cloning some prototype object representative of the class.

The object warehouse means that attached to the class is its extension, i.e., the set of objects that are instances of the class. The user can manipulate the warehouse by applying operations on all elements of the class. Classes are not used for checking the correctness of a program but rather to create and manipulate objects. In most systems that employ the class mechanism, classes are first class citizens and, as such, can be manipulated at run-time. i.e., updated or passed as parameters. In most cases, while providing the system with increased flexibility and uniformity, this renders compile-time type checking impossible.

Of course, there are strong similarities between classes and types, the names have been used with both meanings and the differences can be subtle in some systems.

We do not feel that we should choose one of these two approaches and we consider the choice between the two should be left to the designer of the system. We require, however, that the system should offer some form of data structuring mechanism, be it classes or types. Thus the classical notion of database schema will be replaced by that of a set of classes or a set of types.

We do not, however, feel that is necessary for the system to automatically maintain the extent of a type (i.e., the set of objects of a given type in the database) or, if the extent of a type is maintained, for the system to make it accessible to the user. Consider, for example, the rectangle type, which can be used in many databases by multiple users. It does not make sense to talk about the set of all rectangles maintained by the system or to perform operations on them. We think it is more realistic to ask each user to maintain and manipulate its own set of rectangles. On the other hand, in the case of a type such as employee, it might be nice for the system to automatically maintain the employee extent.

### 5. Class or Type Hierarchies

Inheritance has two advantages: it is a powerful modeling tool, because it gives a concise and precise description of the world and it helps in factoring out shared specifications and implementations in applications. An example will help illustrate the interest in having the system provide an inheritance mechanism. Assume that we have Employees and Students. Each Employee has a name, an age above 18 and a salary, he or she can die, get married and be paid (how dull is the life of the Employee!). Each Student has an age, a name and a set of grades. He or she can die, get married and have his or her CPA computed.

In a relational system, the data base designer defines a relation for Employee, a relation for Student, writes the code for the die, marry and pay operations on the Employee relation, and writes the code for the die, marry and GPA computation for the Student relation. Thus, the application programmer writes six programs.

In an object-oriented system, using the inheritance property, we recognize that Employees and Students are Persons; thus, they have something in common (the fact of being a Person), and they also have something specific. We introduce a type Person, which has attributes name and age and we write the operations die and marry for this type. Then, we declare that Employees are special types of Persons, who inherit attributes and operations, and have a special attribute salary and a special operation pay. Similarly, we declare that a Student is a special kind of Person, with a specific set-of-grades attribute and a special operation CPA computation. In this case, we have a better structured and more concise description of the schema (we factored out specification) and we have only written four programs (we factored out implementation). Inheritance helps code reusability, because every program is at the level at which the largest number of objects can share it. There are at least four types of inheritance: substitution inheritance, inclusion inheritance, constraint inheritance and specialization inheritance.

In substitution inheritance, we say that a type t inherits from a type t′, if we can perform more operations on objects of type t than on object of type t′. Thus, any place where we can have an object of type t′, we can substitute for it an object of type t. This kind of inheritance is based on behavior and not on values.

Inclusion inheritance corresponds to the notion of classification. It states that t is subtype of t′, if every object of type t is also an object of type t′. This type of inheritance is based on structure and not on operations. An example is a square type with methods get, set(size) and filled-square, with methods get, set(size), and fill(color).

Constraint inheritance is a subcase of inclusion inheritance. A type t is a subtype of a type t′, if it consists of all objects of type t which satisfy a given constraint. An example of such a inheritance is that teenager is a subclass of person: teenagers don't have any more fields or operations than persons but they obey more specific constraints (their age is restricted to be between 13 and 19).

With specialization inheritance, a type t is a subtype of a type t′, if objects of type t are objects of type t which contains more specific information. Examples of such are persons and employees where the information on employees is that of persons together with some extra fields.

Various degrees of these four types of inheritance are provided by existing systems and prototypes, and we do not prescribe a specific style of inheritance.

### 6. Overriding, Overloading and Late Binding

In contrast to the previous example, there are cases where one wants to have the same name used for different operations. Consider, for example, the display operation: it takes an object as input and displays it on the screen. Depending on the type of the object, we want to use different display mechanisms. If the object is a picture, we want it to appear on the screen. If the object is a person, we want some form of a tuple printed.

Finally, if the object is a graph, we will want its graphical representation. Consider now the problem of displaying a set, the type of whose members is unknown at compile time.

In an application using a conventional system, we have three operations: display-person, display-bitmap and display-graph. The programmer will test the type of each object in the set and use the corresponding display operation. This forces the programmer, to be aware of all the possible types of the objects in the set, to be aware of the associated display operation, and to use it accordingly.

```
for x in X do
  begin
    case of type(x)
      person: display(x);
      bitmap: display-bitmap(x);
      graph: display-graph(x);
    end
  end
```

In an object-oriented system, we define the display operation at the object type level (the most general type in the system). Thus, display has a single name and can be used indifferently on graphs, persons and pictures. However, we redefine the implementation of the operation for each of the types according to the type (this redefinition is called overriding). This results in a single name (display) denoting three different programs (this is called overloading). To display the set of elements, we simply apply the display operations to each one of them, and let the system pick the appropriate implementation at run-time.

for x in X do display(x)

Here, we gain a different advantage: the type implementors still write the same number of programs. But the application programmer does not have to worry about three different programs. In addition, the code is simpler as there is no case statement on types.

Finally, the code is more maintainable as when a new type is introduced as new instance of the type are added, the display program will continue to work without modification (provided that we override the display method for that new type).

In order to provide this new functionality, the system cannot bind operation names to programs at compile time. Therefore, operation names must be resolved (translated into program addresses) at run-time. This delayed translation is called is called late binding.

Note that, even though late binding makes type checking more difficult (and in some cases impossible), it does not preclude it completely.

### 7. Computational Completeness

From a programming language point of view, this property is obvious: it simply means that one can express any computable function, using the DML of the database system. From a database point of view this is a novelty, since SQL for instance is not complete.

We are not advocating here that designers of object-oriented database systems design new programming languages: computational completeness can be introduced through a reasonable connection to existing programming languages. Most systems indeed use an existing programming language. Note that this is different from being “resource complete”. i.e. being able to access all resources of the system (e.g. screen and remote communication) from within the language. Therefore, the system, even though computationally complete might not be able to express a complete application. It is, however, more powerful than a database system which only stores and retrieves data and performs simple computations on atomic values.

### 8. Extensibility

The database system comes with a set of predefined types. These types can be used at will by programmers to write their applications. This set of type must be extensible in the following sense: there is a means to define new types and there is no distinction in usage between system defined and user defined types.

Of course, there might be a strong difference in the way system and user defined types are supported by the system, but this should be invisible to the application and to the application programmer. Recall that this type definition includes the definition of operations on the types. Note that the encapsulation requirement implies that there will be a mechanism for defining new types. This requirement strengthens that capability by saying that newly created types must have the same status as existing ones.

It will be recognized that the foregoing is but one example of an apparatus and method within the scope of the present invention and that various modifications will occur to those skilled in the art upon reading the disclosure set forth hereinbefore.

1. A method for emulating an Object-Oriented database (OODB) on a Relational database, comprising:
a. define the desired data structure as objects for an Object-Oriented database;
b. for each object, open an RDB table;
c. for each object, in the RDB table, define relevant fields;
d. implement an OODB interface with the user while storing the information in RDB tables.

2. The emulating method according to claim 1, wherein child objects inherit the parent's fields.

3. The emulating method according to claim 2, wherein child objects also include additional fields.

4. The emulating method according to claim 1, wherein fields in RDB tables for People objects include all or part of the following:
serial number, Item-id, Forename, Surname, ID No., Position, Phone_Number, Fax_Number.

5. The emulating method according to claim 1, wherein fields in RDB tables for Managers objects include a list of their subordinate employees.

6. The emulating method according to claim 1, wherein fields in RDB tables for Customers objects include a telephone number, fax number, email address.

7. The emulating method according to claim 1, wherein fields in RDB tables for Resources objects include a serial number, Item-id, Cost.

8. A method for emulating an Object-Oriented database (OODB) on a Relational database and for distinguishing between OODB objects, comprising:
a. define the desired data structure as objects for an Object-Oriented database;
b. for each object, open an RDB table;
c. for each object, in the RDB table, define relevant fields;
d. allocate a unique primary number, object-id to each new object;
e. allocate a second number, item-id, to each new object, wherein its value is computed as the product of its object-id and its parent's object-id;
f. implement a method to support the application of SELECT commands over the tables using the object-id and item-id numbers, to return the relevant objects (views).

9. The emulating method according to claim 8, wherein child objects inherit the parent's fields.

10. The emulating method according to claim 8, wherein a new object is created as the child of two parents.
